(19) United States
(12) Patent Application Publication
(10) Pub. No.: US 2024/0331446 A1
(43) Pub. Date: Oct. 3, 2024

(54) SYSTEMS AND METHODS FOR AUTOMATIC HAND GESTURE RECOGNITION

(71) Applicant: Shanghai United Imaging Intelligence Co., Ltd., Shanghai (CN)

(72) Inventors: Zhongpai Gao, Rowley, MA (US); Abhishek Sharma, Boston, MA (US); Meng Zheng, Cambridge, MA (US); Benjamin Planche, Briarwood, NY (US); Ziyan Wu, Lexington, MA (US); Terrence Chen, Lexington, MA (US)

(73) Assignee: Shanghai United Imaging Intelligence Co., Ltd., Shanghai (CN)

(21) Appl. No.: 18/126,853

(22) Filed: Mar. 27, 2023

(51) Int. Cl. G06V 40/20; G06V 10/26; G06V 10/40; G06V 10/82; G06V 40/10

(52) U.S. Cl. CPC G06V 40/20; G06V 10/26; G06V 10/40; G06V 10/82; G06V 40/11; G06V 10/774; G06V 2201/03

(57) ABSTRACT

Automatic hand gesture determination may be a challenging task considering the complex anatomy and high dimensionality of the human hand. Disclosed herein are systems, methods, and instrumentalities associated with recognizing a hand gesture in spite of the challenges. An apparatus in accordance with embodiments of the present disclosure may use machine learning based techniques to identify the area of an image that may contain a hand and to determine an orientation of the hand relative to a pre-defined direction. The apparatus may then adjust the area of the image containing the hand to align the orientation of the hand with the pre-defined direction and/or to scale the image area to a pre-defined size. Based on the adjusted image area, the apparatus may detect a plurality of hand landmarks and predict a gesture indicated by the hand based on the plurality of detected landmarks.

### BACKGROUND

Hand gesture recognition plays an important role in human-machine interaction. Taking a medical environment as an example, a medical professional or a patient may use hand gestures to convey a variety of information including, for example, the condition of certain medical equipment (e.g., whether a scan bed is at the right height), the readiness of the patient (e.g., with respect to a scan or surgical procedure), the pain level of the patient (e.g., on a scale of 1 to 10), etc. As such, having the ability to automatically recognize these hand gestures may allow the medical environment to operate more efficiently and with less human intervention. Conventional techniques for hand gesture recognition may be error-prone due to the complex anatomy and high dimensionality of a human hand. Therefore, systems and methods that are capable of accurately determining the meanings of hand gestures may be desirable.

### SUMMARY

Disclosed herein are systems, methods, and instrumentalities associated with automatic hand gesture recognition. According to embodiments of the present disclosure, an apparatus configured to perform the hand gesture recognition task may include at least one processor configured to obtain an image and determine, based on a first machine learning (ML) model, an area of the image that may correspond to a hand and an orientation of the hand relative to a pre-defined direction. The at least one processor may be further configured to adjust the area of the image that may correspond to the hand to at least align the orientation of the hand with the pre-defined direction. The at least one processor may then detect, based on a second ML model, a plurality of landmarks associated with the hand in the adjusted area of the image, and determine a gesture indicated by the hand based on the plurality of detected landmarks.

In examples, the apparatus described herein may determine the orientation of the hand relative to the pre-defined direction terms of an angle between an area of the hand (e.g., an imaginary line running through the palm of the hand) and the pre-defined direction, which may be adjustable. In examples, the at least one processor of the apparatus may be configured to determine the area of the image that may correspond to the hand by determining a bounding shape (e.g., bounding box) that may surround the area of the image corresponding to the hand. In examples, the at least one processor of the apparatus may be configured to adjust the area of the image that may correspond to the hand by cropping the area of the image corresponding to the hand based on the bounding shape and rotating the cropped image area (e.g., based on the angle determined the previous step) to align the orientation of the hand with the pre-defined direction. In examples, the at least one processor may be further configured to adjust the area of the image that may correspond the hand by scaling the cropped area of the image to a pre-determined size.

In examples, the plurality of landmarks described herein may include a plurality of joint locations of the hand and the at least one processor may be configured to determine the hand gesture determining at least one of a shape or a pose of the hand based on the plurality of landmarks and by matching the at least one of the determined shape or pose of the hand with a hand shape or a hand pose associated with a pre-defined gesture class (e.g., such as “OK,” “Not OK,” etc.). In examples, at least one of the first ML model or the second ML model may be implemented using a convolutional neural network (CNN), and the second ML model may be trained based on images in which a hand may be oriented in the pre-defined direction. In examples, the image used by the apparatus to determine the hand gesture may include a two-dimensional color image of a medical environment (e.g., a scan room, an operating room, etc.), and the apparatus may be further configured to process a task associated with the medical environment (e.g., positioning of a patient) based on the determined hand gesture.

### BRIEF DESCRIPTION OF THE DRAWINGS

A more detailed understanding of the examples disclosed herein may be obtained from the following description, given by way of example in conjunction with the accompanying drawing.

FIG. 1 is a simplified diagram illustrating an example of automatic hand gesture recognition in accordance with one or more embodiments of the present disclosure.

FIG. 2 is a simplified block diagram illustrating example techniques that may be used to perform a hand gesture recognition task in accordance with one or more embodiments of the present disclosure.

FIG. 3 is a flow diagram illustrating an example procedure for automatically determining a hand gesture in accordance with one or more embodiments of the present disclosure.

FIG. 4 is a simplified flow diagram illustrating an example process for training an artificial neural network to perform one or more of the tasks described in one or more embodiments of the present disclosure.

FIG. 5 is a simplified block diagram illustrating example components of an apparatus that may be used to perform the hand recognition task described in one or more embodiments of the present disclosure.

### DETAILED DESCRIPTION

The present disclosure is illustrated by way of example, and not by way of limitation, in the figures of the accompanying drawings. A detailed description of illustrative embodiments will be described with reference to the figures. Although this description may provide detailed examples of possible implementations, it should be noted that the details are intended to be illustrative and in no way limit the scope of the application. It should also be noted that while the examples may be described in the context of a medical environment, those skilled in the art will appreciate that the disclosed techniques may also be applied to other environments or use cases.

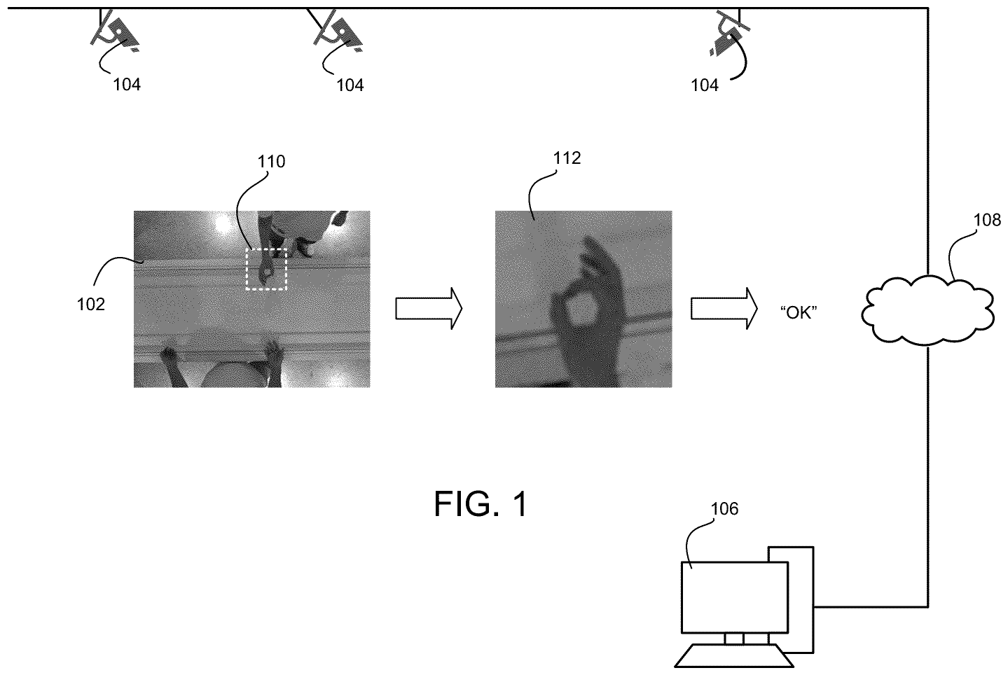

FIG. 1 illustrates an example of automatic hand gesture recognition in accordance with embodiments of the present disclosure. As shown, the hand gesture recognition may be accomplished based on an image 102 of an environment captured using a sensing device 104 (e.g., a camera, a depth sensor, a thermal imaging sensor, a radar sensor, or a combination thereof) installed in the environment. The environment may be, for example, a medical environment such as a scan room (e.g., with a computed tomography (CT) or magnetic resonance imaging (MRI) scanner) or an operating room (e.g., with a surgery table), and image 102 may be a color image (e.g., a 2D color image) that depicts respective positions, shapes, and/or poses of one or more hands in the medical environment. Sensing device 104 may be configured to provide image 102 to a processing apparatus 106 (e.g., over a wired or wireless communication link 108), while processing apparatus 106 may be configured to obtain the image, detect the one or more hands in the image, and further determine a gesture indicated by the one or more hands based on features and/or landmarks detected in the image. For example, processing apparatus 106 may be configured to identify a hand in area 110 of image 102, crop that area out of the image, and analyze the cropped area 112 (e.g., upon making certain adjustments to the cropped area) to determine the gesture indicated by the shape and/or pose of the hand depicted in the image. The determination may be made, for example, based on a set of pre-defined gesture classes and by matching the shape and/or pose of the hand depicted in the image to one of the pre-defined classes. For instance, upon analyzing cropped image area 112, processing apparatus 106 may determine that the shape and/or pose of the hand in the image area belong to a class of “OK” gestures, and may generate an output (e.g., a classification label) indicating the classification accordingly.

The hand gesture determination or prediction made by processing apparatus 106 may be used for a variety of purposes. For example, where processing apparatus 106 is used to detect and recognize hand gestures in a medical environment (e.g., a scan room or an operating room), the determination made by the processing apparatus may be used to evaluate the readiness of a patient for a medical procedure (e.g., with respect to the positioning of the patient and/or other preoperative routines) or whether a medical device has been properly prepared for the medical procedure (e.g., whether a scanner has been properly calibrated and/or oriented, whether a patient bed has been set at the right height, etc.). In some examples, processing apparatus 106 may be configured to perform the aforementioned evaluation and provide an additional input indicating the output of the evaluation, while in other examples the processing apparatus may pass the hand gesture determination to another device (e.g., a device located remotely from the medical environment) so that the other device may use the determined hand gesture in an application-specific task.

It should be noted here that while processing apparatus 106 may be shown in FIG. 1 as being separate from sensing device 104, those skilled in the art will appreciate that the processing apparatus may also be co-located with the sensing device (e.g., as an on-board processor of the sensing device) without affecting the functionality of the processing apparatus or the sensing device as described herein.

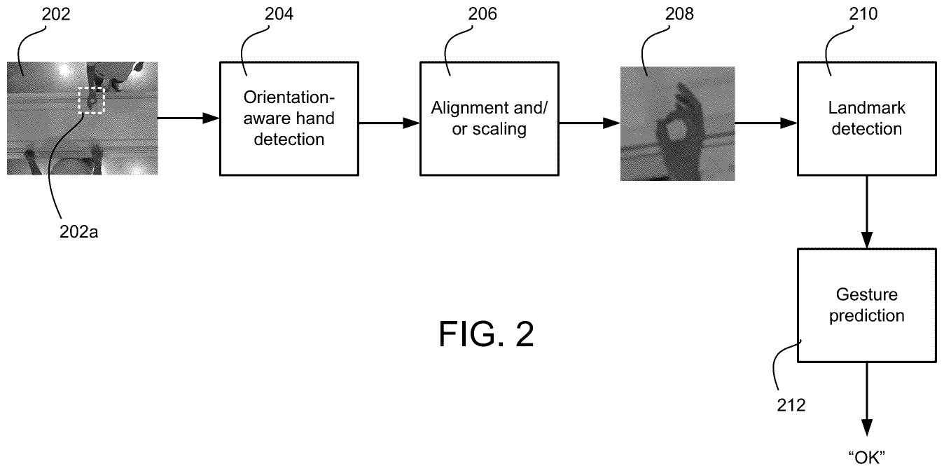

FIG. 2 illustrates example techniques that may be used to perform the hand gesture recognition task shown in FIG. 1. As described above, a gesture recognition apparatus (e.g., processing apparatus 106 of FIG. 1) configured to perform the hand recognition task may obtain an image 202 of an environment (e.g., a medical environment) that may capture a hand gesture made by a person (e.g., a patient or a medical professional) in the environment. The gesture recognition apparatus may process the image at 204 based on a first machine learning (ML) model that may have been pre-trained for identifying the area of the image that may include the hand and for determining an orientation of the hand, for example, relative to a pre-defined direction (e.g., an upright direction). The first ML model may be implemented using an artificial neural network (ANN) comprising a first plurality of layers trained for extracting features from image 202 and determining, based on the extracted features, which area (e.g., pixels) of the image may include the hand. The ANN may, for example, be trained to generate a bounding shape 202a (e.g., a bounding box) around the image area that may correspond to the hand based on the features extracted from image 202.

In examples, the ANN may further include a second plurality of layers trained for predicting an orientation of the hand based on the features extracted from image 202. The ANN may predict the orientation of the hand, for example, as an angle (e.g., a number of degrees) between an area of the hand (e.g., an imaginary line drawn through the palm of the hand) and a pre-defined direction (e.g., which may be represented by a vector), and may indicate the predicted orientation in terms of the angle and as an output of the ANN. For example, by processing image 202 through the first and second pluralities of layers, the ANN may output a vector [x1, x2, y1, y2, ori., conf.], where [x1, x2, y1, y2] may define a bounding box surrounding the image area that contains the hand, [ori.] may represent the orientation of the hand, and [conf.] may represent a confidence level or score for the prediction (e.g., prediction of the bounding box and/or the hand orientation). As will be described in greater detail below, information obtained through the orientation-aware hand detection operation at 204 may be used to reduce the uncertainty and/or complexity associated hand shape/pose determination, thereby simplifying the gesture prediction task for the gesture recognition apparatus.

In response to determining the area of image 202 that contains the hand and the orientation of the hand, the gesture recognition apparatus may be configured to adjust the determined image area at 206 to at least align the hand as depicted by the image area with the pre-defined direction described above. The gesture recognition apparatus may do so, for example, by cropping the image area that contains the hand (e.g., based on bounding shape 202a) from image 202 and rotating the cropped image section by the angle determined at 204. In examples, the gesture recognition apparatus may be further configured to scale (e.g., enlarge) the cropped image section to a pre-determined size (e.g., 256×256 pixels), e.g., to zoom in on the hand. The pre-defined direction used to guide the rotation of the cropped image section may be adjustable, for example, based on how an ML model (e.g., the second ML model described below) for predicting a hand gesture based on the cropped image section may have been trained. Similarly, the image size to which the cropped image section is scaled may also be adjustable based on how the ML model for predicting the hand gesture may have been trained. Through one or more of the rotation or scaling, the gesture recognition apparatus may obtain an adjusted image of the hand at 208 with a desired (e.g., fixed) orientation and/or size to eliminate the potential ambiguities and/or complexities that may arise from having a variable image orientation and/or image size. Further, by including the image alignment and/or scaling operation of 206 as a part of the hand gesture recognition workflow, an ML gesture prediction model trained based on images of a specific orientation and/or size may still be employed to process images of other orientations and/or sizes, for example, by adjusting those images in accordance with the operations described with respect to 206.

Using the adjusted hand image derived at 208, the gesture recognition apparatus may detect, based on a second ML model, a plurality of landmarks associated with the hand at 210 and further determine the gesture indicated by the positions of those landmarks at 212. Similar to the image orientation and/or image size described above, the plurality of landmarks detected by the gesture recognition apparatus at 210 may also be pre-defined, for example, to include all or a subset of the joints in a human hand and/or other shape or pose-defining anatomical components (e.g., finger tips) of the human hand. Like the first ML model described above, the second ML model may also be implemented using an ANN that may be trained for extracting features from the adjusted hand image and determining the respective positions of the landmarks based on the extracted features. The training of such an ANN (e.g., to learn the second ML model) may be conducted using a publicly available dataset, which may include hand images of the same orientation and/or size, or hand images of different orientations and/or sizes. In either scenario, the orientations and/or sizes of the training images may be adjusted to a pre-defined orientation and/or size that may correspond to the pre-defined direction used to rotate the bounding shape 202a and the pre-defined image size used to scale the bounding shape 202a, respectively. Through such training and given the adjusted hand image derived at 208, the ANN may generate a heatmap at 210 to indicate (e.g., with respective probability or confidence scores) the areas or pixels of the adjusted hand image that may correspond to the detected landmarks. From these landmarks, the gesture recognition apparatus may then determine the shape and/or pose of the hand depicted in image 202 and make a prediction about the class of gestures (e.g., among a pre-defined set of gesture classes) that the hand may belong to at 212 (e.g., by producing a classification label for the hand gesture).

In example implementations, the ANN described herein (e.g., for implementing the first ML model or the second ML model) may include a convolutional neural network (CNN) comprising an input layer, one or more convolutional layers, one or more pooling layers, and/or one or more fully-connected layers. The input layer may be configured to receive an input image (e.g., image 202 of FIG. 1), while each of the convolutional layers may include a plurality of convolution kernels or filters with respective weights for extracting features from the input image. The convolutional layers may be followed by batch normalization and/or linear or non-linear activation (e.g., such as a rectified linear unit (ReLU) activation function), and the features extracted from the convolution operations may be down-sampled through one or more pooling layers to obtain a representation of the features, for example, in the form of a feature vector or feature map. In example implementations, the CNN may further include one or more un-pooling layers and one or more transposed convolutional layers. Through the un-pooling layers, the features extracted through the convolution operations described above may be up-sampled, and the up-sampled features may be further processed through the one or more transposed convolutional layers (e.g., via a plurality of deconvolution operations) to derive an up-scaled or dense feature map or feature vector, which may then be used to generate a heatmap or a mask indicating a plurality of landmarks associated with a hand and/or an orientation of the hand.

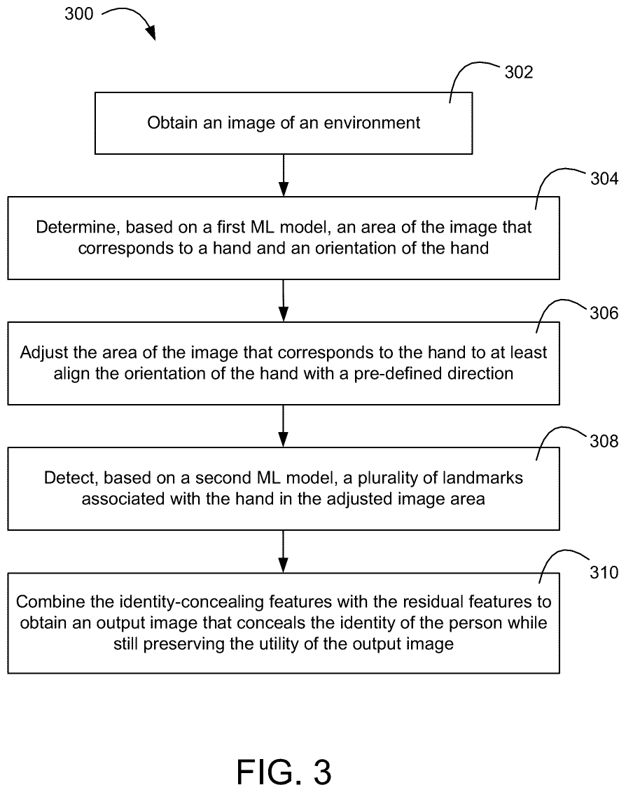

FIG. 3 illustrates an example process 300 that may be implemented by a gesture recognition apparatus for automatically determining a hand gesture. As shown, process 300 may include obtaining an image of an environment (e.g., a medical environment) at 302, and determining, based on a first machine learning (ML) model, an area of the image that may contain a hand and an orientation of the hand (e.g., relative to a pre-defined direction) at 304. Based on the determined orientation of the hand, the process may further include adjusting, at 306, the area of the image that may contain the hand (e.g., upon cropping the area out of the input image) to at least align the orientation of the hand with the pre-defined direction (e.g., the image area containing the hand may also be scaled to a pre-defined size). Subsequently, process 300 may proceed to 308, where a plurality of landmarks associated with the hand may be detected from the adjusted image area containing the hand, and a determination about the gesture indicated by the hand may be made at 310 based on the plurality of landmarks detected in the adjusted image area.

For simplicity of explanation, process 300 may be depicted and described herein with a specific order. It should be appreciated, however, that the illustrated operations may be performed in various orders, concurrently, and/or with other operations not presented or described herein. Furthermore, it should be noted that not all operations that may be included in process 300 are depicted and described herein, and not all illustrated operations are required to be performed.

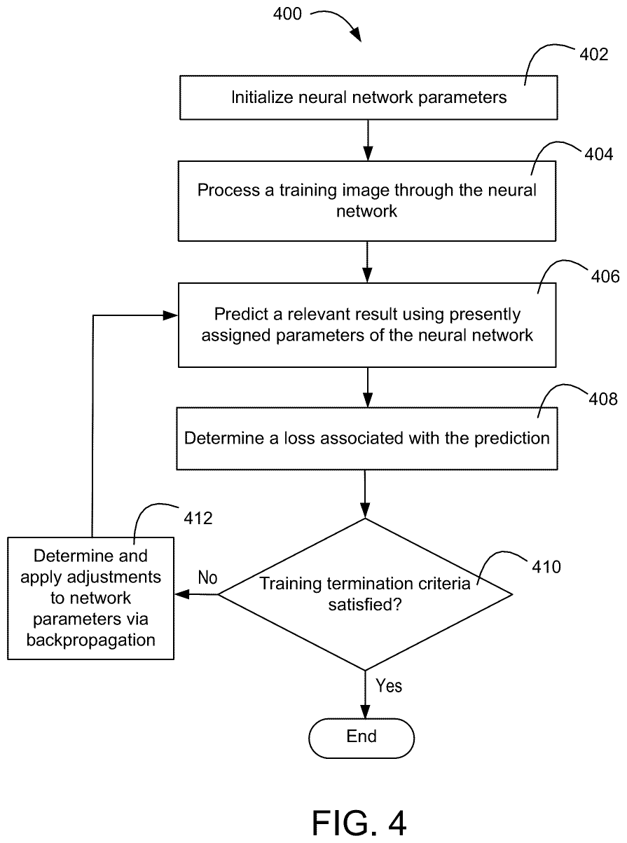

FIG. 4 illustrates an example process 400 for training an artificial neural network to perform one or more of the tasks described herein. As shown, the training process may include initializing parameters of the neural network (e.g., weights associated with various layers of the neural network) at 402, for example, based on samples from one or more probability distributions or parameter values of another neural network having a similar architecture. The training process may further include processing a training image (e.g., an input image of a hand) at 404 using presently assigned parameters of the neural network, and making a prediction about a result (e.g., a bounding box around an image area containing the hand, landmarks associated with the hand, etc.) at 406. The prediction may then be compared to a ground truth at 408 to determine a loss associated with the prediction. Such a loss may be determined, for example, based on a mean absolute error (MAE), a mean squared error (MSE), a normalized mean error (NME) between the predicted result and the ground truth, an L1 norm, an L2 norm, etc. At 410, the loss may be evaluated to determine whether one or more training termination criteria are satisfied. For example, the training termination criteria may be determined to be satisfied if the loss is below a threshold value or if the change in the loss between two training iterations falls below a threshold value. If the determination at 410 is that the termination criteria are satisfied, the training may end; otherwise, the presently assigned network parameters may be adjusted at 412, for example, by backpropagating a gradient descent of the loss function through the network before the training returns to 406.

For simplicity of explanation, the training operations are depicted and described herein with a specific order. It should be appreciated, however, that the training operations may occur in various orders, concurrently, and/or with other operations not presented or described herein. Furthermore, it should be noted that not all operations that may be included in the training process are depicted and described herein, and not all illustrated operations are required to be performed.

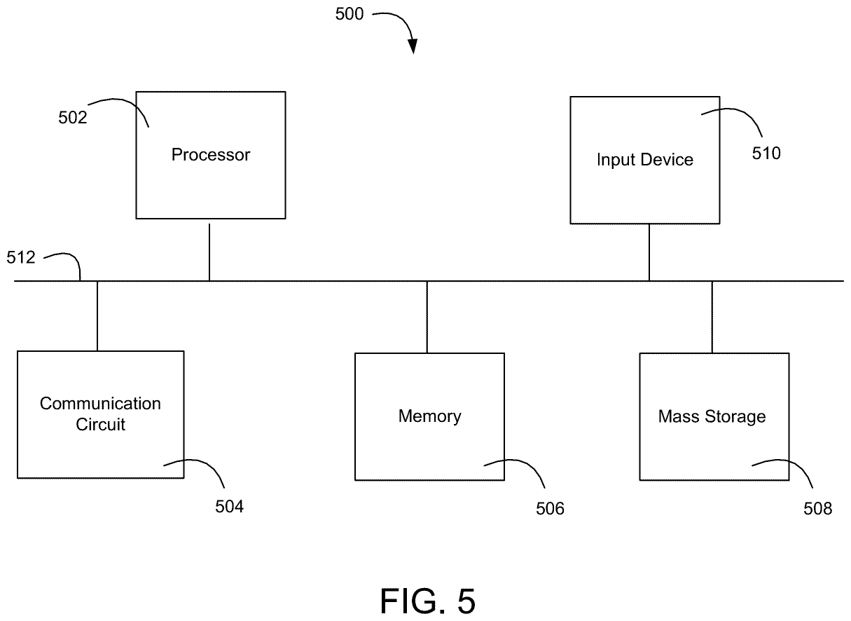

The systems, methods, and/or instrumentalities described herein may be implemented using one or more processors, one or more storage devices, and/or other suitable accessory devices such as display devices, communication devices, input/output devices, etc. FIG. 5 is a block diagram illustrating an example apparatus 500 that may be configured to perform the gesture recognition tasks described herein. As shown, apparatus 500 may include a processor (e.g., one or more processors) 502, which may be a central processing unit (CPU), a graphics processing unit (GPU), a microcontroller, a reduced instruction set computer (RISC) processor, application specific integrated circuits (ASICs), an application-specific instruction-set processor (ASIP), a physics processing unit (PPU), a digital signal processor (DSP), a field programmable gate array (FPGA), or any other circuit or processor capable of executing the functions described herein. Apparatus 500 may further include a communication circuit 504, a memory 506, a mass storage device 508, an input device 510, and/or a communication link 512 (e.g., a communication bus) over which the one or more components shown in the figure may exchange information.

Communication circuit 504 may be configured to transmit and receive information utilizing one or more communication protocols (e.g., TCP/IP) and one or more communication networks including a local area network (LAN), a wide area network (WAN), the Internet, a wireless data network (e.g., a Wi-Fi, 3G, 4G/LTE, or 5G network). Memory 506 may include a storage medium (e.g., a non-transitory storage medium) configured to store machine-readable instructions that, when executed, cause processor 502 to perform one or more of the functions described herein. Examples of the machine-readable medium may include volatile or non-volatile memory including but not limited to semiconductor memory (e.g., electrically programmable read-only memory (EPROM), electrically erasable programmable read-only memory (EEPROM)), flash memory, and/or the like. Mass storage device 508 may include one or more magnetic disks such as one or more internal hard disks, one or more removable disks, one or more magneto-optical disks, one or more CD-ROM or DVD-ROM disks, etc., on which instructions and/or data may be stored to facilitate the operation of processor 502. Input device 510 may include a keyboard, a mouse, a voice-controlled input device, a touch sensitive input device (e.g., a touch screen), and/or the like for receiving user inputs to apparatus 500.

It should be noted that apparatus 500 may operate as a standalone device or may be connected (e.g., networked, or clustered) with other computation devices to perform the functions described herein. And even though only one instance of each component is shown in FIG. 5, a skilled person in the art will understand that apparatus 500 may include multiple instances of one or more of the components shown in the figure.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining.” “enabling.” “identifying.” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. An apparatus, comprising:
at least one processor configured to:
obtain an image;
determine, based on a first machine learning (ML) model, an area of the image that corresponds to a hand and an orientation of the hand relative to a pre-defined direction;
adjust the area of the image that corresponds to the hand to at least align the orientation of the hand with the pre-defined direction;
detect, based on a second ML model, a plurality of landmarks associated with the hand in the adjusted area of the image; and
determine a gesture indicated by the hand based on the plurality of landmarks detected in the adjusted area of the image.

2. The apparatus of claim 1, wherein the orientation of the hand relative to the pre-defined direction is determined in terms of an angle between an area of the hand and the pre-defined direction.

3. The apparatus of claim 1, wherein the at least one processor being configured to determine the area of the image that corresponds to the hand comprises the at least one processor being configured to determine a bounding shape that surrounds the area of the image corresponding to the hand.

4. The apparatus of claim 3, wherein the at least one processor being configured to adjust the area of the image that corresponds to the hand to at least align the orientation of the hand with the pre-defined direction comprises the at least one processor being configured to crop the area of the image corresponding to the hand based on the bounding shape and to rotate the cropped area of the image to align the orientation of the hand with the pre-defined direction.

5. The apparatus of claim 4, wherein the at least one processor being configured to adjust the area of the image that corresponds the hand further comprises the at least one processor being configured to scale the cropped area of the image to a pre-determined size.

6. The apparatus of claim 1, wherein the plurality of landmarks associated with the hand includes a plurality of joint locations of the hand.

7. The apparatus of claim 1, wherein the at least one processor being configured to determine the gesture indicated by the hand based on the plurality of landmarks associated with the hand comprises the at least one processor being configured to determine at least one of a shape or a pose of the hand based on the plurality of landmarks and to match the at least one of the shape or pose of the hand with a hand shape or a hand pose associated with a pre-defined gesture class.

8. The apparatus of claim 1, wherein at least one of the first ML model or the second ML model is implemented using a convolutional neural network, and wherein the second ML model is trained based on images in which a hand is oriented in the pre-defined direction.

9. The apparatus of claim 1, wherein the image includes a two-dimensional color image of a medical environment.

10. The apparatus of claim 1, wherein the at least one processor is further configured to process a task based on the determined gesture of the hand.

11. A method of hand gesture recognition, the method comprising:
obtaining an image;
determining, based on a first machine learning (ML) model, an area of the image that corresponds to a hand and an orientation of the hand relative to a pre-defined direction;
adjusting the area of the image that corresponds to the hand to at least align the orientation of the hand with the pre-defined direction;
detecting, based on a second ML model, a plurality of landmarks associated with the hand in the adjusted area of the image; and
determining a gesture indicated by the hand based on the plurality of landmarks detected in the adjusted area of the image.

12. The method of claim 11, wherein the orientation of the hand relative to the pre-defined direction is determined in terms of an angle between an area of the hand and the pre-defined direction.

13. The method of claim 11, wherein determining the area of the image that corresponds to the hand comprises determining a bounding shape that surrounds the area of the image corresponding to the hand.

14. The method of claim 13, wherein adjusting the area of the image that corresponds to the hand to at least align the orientation of the hand with the pre-defined direction comprises cropping the area of the image corresponding to the hand based on the bounding shape and rotating the cropped area of the image to align the orientation of the hand with the pre-defined direction.

15. The method of claim 14, wherein adjusting the area of the image that corresponds the hand further comprises scaling the cropped area of the image to a pre-determined size.

16. The method of claim 11, wherein the plurality of landmarks associated with the hand includes a plurality of joint locations of the hand.

17. The method of claim 11, wherein determining the gesture indicated by the hand based on the plurality of landmarks associated with the hand comprises determining at least one of a shape or a pose of the hand based on the plurality of landmarks and matching the at least one of the shape or pose of the hand with a hand shape or a hand pose associated with a pre-defined gesture class.

18. The method of claim 11, wherein at least one of the first ML model or the second ML model is implemented using a convolutional neural network, and wherein the second ML model is trained based on images in which a hand is oriented in the pre-defined direction.

19. The method of claim 11, wherein the image includes a two-dimensional color image of a medical environment and wherein the method further comprises performing a task associated with the medical environment based on the determined gesture of the hand.

20. A non-transitory computer-readable medium comprising instructions that, when executed by a processor included in a computing device, cause the processor to implement the method of claim 11.
